(19) United States
(12) Patent Application Publication
(10) Pub. No.: US 2013/0311363 A1
(43) Pub. Date: Nov. 21, 2013

(54) DYNAMICALLY RE-PROGRAMMABLE TRANSACTION CARD

(71) Applicant: Jonathan E. Ramaci, Isle of Palms, SC (US)

(72) Inventor: Jonathan E. Ramaci, Isle of Palms, SC (US)

(21) Appl. No.: 13/892,738

(22) Filed: May 13, 2013

Related U.S. Application Data
(60) Provisional application No. 61/647,212, filed on May 15, 2012.

(51) Int. Cl. G06Q 20/10

(52) U.S. Cl. CPC G06Q 20/105
USPC 705/41

(57) ABSTRACT

A dynamically re-programmable transaction card is capable of dynamically changing the information stored on various data tracks included on a magnetic strip(s) of the card. The information may be payment information associated with payment card, such as a credit card, debit card, gift card, etc., such that a user may select a payment type/card for a pending transaction and the data tracks may be dynamically programmed just prior to the pending transaction to allow for a transaction to processed using the user-selected payment information. During the period of time for which the transaction card is programmed, the card emulates the physical embodiment of the payment card selected. Additionally, the transaction card may be dynamically programmed with any other information needed to conduct a transaction that is typically stored on other convention magnetic stripe cards, such as loyalty card information, key code information (e.g., card-like hotel keys) and the like.

### FIELD

In general, embodiments of the invention relate to a device for conducting transactions and, more particularly, to a dynamically programmable transaction card that eliminates the need for the user to carry and use multiple credit cards, loyalty cards, gift cards and the like.

### BACKGROUND

Typically, consumers carry a wallet that contains multiple different payment cards, such as credit cards and debit cards, as well as, gift cards. In addition to such payment cards, a consumer's wallet may include other cards, such as loyalty cards, key cards and the like. As a consumer adds more and more cards to the wallet, the physical size of the wallet increases, which is burdensome to the consumer since the wallet is typically in the possession of the consumer at all times. In many instances, the consumer resorts to limiting the number of cards in their wallet to ensure that the wallet is manageable in terms of size. In such instances, it is only a matter of time before the consumer is confronted with a situation in which a specific card is desired for a transaction, entry or the like, only for the consumer to realize that is not currently in their physical possession.

In addition, the need to carry multiple payment cards and the like, poses serious security-related issues in the event that the wallet containing the payment cards is lost or stolen. The consumer runs the risk that the cards may be used by an unauthorized possessor and, in certain instances, financially responsible for such unauthorized transactions. At the very least, the consumer is burdened with having to contact each of the card issuers to cancel and request replacement of the stolen/lost cards and without having access to the card for a period time. Moreover, if the consumer carries multiple payment cards and one single card is lost or stolen, the consumer may not initially become aware that the card has been stolen or is lost, exasperating the length of time that an unauthorized possessor may conduct unauthorized/fraudulent transactions prior to the card (i.e., the account associated with the card) is cancelled.

Therefore, a need exists to develop systems, methods, devices and the like that address the aforementioned concerns. The desired invention should eliminate the need for a consumer to simultaneously carry multiple payment cards, loyalty cards or the like. In addition, the desired invention should eliminate the security risk and inconvenience posed by a consumer losing possession of one or all of the payment cards in their possession.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for a dynamically re-programmable transaction card that is capable of dynamically changing the information stored on the various data tracks included on the magnetic strip(s) of the card. The information may be payment information associated with payment card, such as a credit card, debit card, gift card or the like, such that a user may select a payment type/card for a pending transaction and the data tracks may be dynamically programmed just prior to the pending transaction to allow for a transaction to processed using the user-selected payment information. In this regard, during the period of time for which the transaction card is programmed, the card emulates the physical embodiment of the payment card selected by the user. In addition, to payment information the transaction card of the present invention may be dynamically programmed with any other information needed to conduct a transaction that is typically stored on other convention magnetic stripe cards, such as loyalty card information, key code information (e.g., card-like hotel keys) and the like.

A dynamically re-programmable transaction card device, defines first embodiments of the invention. The device includes a card body including one or more magnetic strips disposed on a facing of the card body. The one or magnetic strips each include a data track that is dynamically re-programmable. The device additionally includes a connector disposed on a facing of the card body. The connector is operable, upon connection to a programming device, to receive programming instructions. In addition, the device includes a processor in electrical communication with the connector and the magnetic strips. The processor is operable to receive the programming instructions from the connector and energize the one or more magnetic strip with the programming instructions.

Thus, systems, apparatus, methods, and computer program products herein described in detail below provide for a dynamically re-programmable transaction card.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of a dynamically re-programmable transaction card, in accordance with the prior art.

### BRIEF DESCRIPTION OF ATTACHMENTS

ATTACHMENT A Title: Card Interface Requirements and Use Cases—Pages 1-14.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a device, a system, a computer program product, a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a non-transitory computer-usable storage medium having computer-usable program code/computer-readable instructions embodied in the medium.

According to embodiments of the invention described herein, provided is a dynamically re-programmable transaction card that is capable of dynamically changing the information stored on the various data tracks included on the magnetic strip(s) of the card. The information may be payment information associated with payment card, such as a credit card, debit card, gift card or the like, such that a user may select a payment type/card for a pending transaction and the data tracks may be dynamically programmed just prior to the pending transaction to allow for a transaction to processed using the user-selected payment information.

In this regard, during the period of time for which the transaction card is programmed, the card emulates the physical embodiment of the payment card selected by the user. In addition, to payment information the transaction card of the present invention may be dynamically programmed with any other information needed to conduct a transaction that is typically stored on other convention magnetic stripe cards, such as loyalty card information, key code information (e.g., card-like hotel keys) and the like.

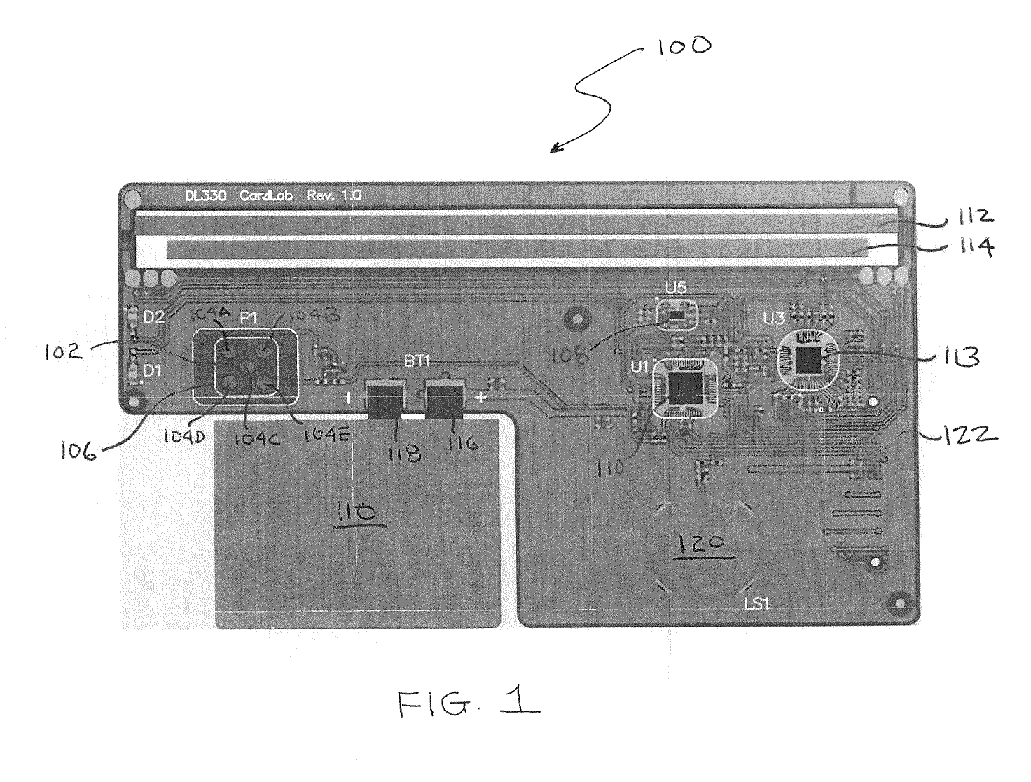

Referring to FIG. 1 a schematic diagram is presented of a dynamically re-programmable transaction card 100, in accordance with embodiments of the present invention. It should be noted that the term “transaction”, as used herein, is not limited to a payment transaction but may include any other transaction or activity that requires data transmission and/or processing for the transaction to occur. For example, the transaction may be crediting of a loyalty points account for a related payment transaction, entry into a building/room with card-like key, entry into an event (i.e., an event ticket), redeeming coupons/offers, communication of health data or the like.

The card 100 includes connection point 102, which provides for connection of the card 100 to a transaction programming apparatus (not shown in FIG. 1). In the illustrated embodiment of FIG. 1 the connection point 102 includes five (5) connectors' 104A-104E that are operable to receive programming instructions from the transaction programming apparatus. In one illustrated embodiments connector 104A and 104E are implemented to move data from the transaction programming apparatus to the card. While five connectors 104A-104E are shown in FIG. 1, in other embodiments of the card 100 fewer or more connectors may be implemented at the connection point 102, as deemed necessary. In one embodiment of the invention, a standard ISO-7816 connector is used that includes eight (8) contacts. In specific embodiments, the card 100 may use a connector that presents six (6) contacts. The information to be presented to the magnetic strips 1124 and 117 may be communicated over the serial contact.

The transaction programming apparatus as described herein may be, in some embodiments, associated with a mobile device, such as being a case or attachment for a mobile device. In other embodiments, the transaction programming apparatus may be embodied within a mobile device, such as mobile/cellular/smart telephone device or the like. In still further embodiments. The transaction programming apparatus may be a standalone device.

The transaction programming apparatus is configured to receive and store transaction data. The transaction data may be associated with conventional cards, such as payment cards, loyalty cards or the like or, in other instances the transaction data may non-card related data. In specific embodiments the transaction programming apparatus may be configured to receive the transaction data via an attached magnetic card reader, which allows for swiping the conventional transaction card to read the data contained thereon and store the data in the transaction programming apparatus. In other embodiments, the transaction programming apparatus may be configured to receive the transaction data may be configure to receive data via wireless or wireless communication with a mobile device, image capture, wireless network access, manual input or the like. The transaction programming apparatus additionally includes a user interface, such as a display and data input mechanisms that allow the user to input authentication credentials and select transaction information for dynamically programming an attached transaction card.

Referring again to FIG. 1, the connectors 104A-104E are in communication with smart chip 106, which may be a security chip, such as an EMV (Europay, MasterCard, VISA) chip. While security chips are typically implemented to store information, such as a user's authentication credentials or the like for the purpose of automated authentication during payment processing, in the present invention the security chip is used to facilitate the connection between the transaction programming apparatus and the card and to communicate the transactions instructions to one or more microprocessors 108, 110 and/or 113 (i.e., inform the card which magnetic strip/track to activate and the duration of the activation).

The card 100 may be configured to acknowledge successful transmission of the of the transactions instructions from the transaction programming apparatus to the card. Such as acknowledgement may be display of a blinking light (not shown in FIG. 1), such as an LED light or the like, embedded in the card and displayable through a facing of the card. Successful transmission may be determined based on checksum transmission, if a calculated checksum for program instructions does not match the checksum transmitted, the card may return an error message. Once successful transmission has been occurred, the card can be unconnected from the transaction programming apparatus. Re-insertion of the card into the transaction programming apparatus will communicate a signal from the apparatus to the card, which causes the card to erase all information stored on the magnetic strips 112 and 114 (i.e., tracks 1 and 2).

It should be noted that while smart chip 106 is operable in the present invention to serve as the contact point it may also be configured and implemented as a security device capable of wirelessly transmitting authentication credentials to a point-of-sale (POS) device during a corresponding payment transaction. In other embodiments of the invention, the need may not exist for a smart chip 106 or any other chip/microprocessor at the connection point 102 to facilitate the connection between the transaction programming apparatus and the card and to communicate the transactions instructions to one or more microprocessors. In such embodiments, in which a smart chip 106 or any other chip/microprocessor is not required, a security chip, such as an EMV chip or the like or the functionality of such a security chip may be disposed elsewhere within the card 100.

Card 100 additionally includes power source 110 operable to provide power to the transaction card 100 for the purpose of energizing the magnetic strips 112 and 114 prior to having the data read from the magnetic strips (i.e., swiped) during a transaction. In the illustrated example the power source 110 is a silver packet battery that is connected to the circuitry of the card 100 via positive terminal 116 and negative terminal 118. In alternate embodiments of the invention power source 110 is a rechargeable cell battery operable to allow the user the ability to recharge the cell as needed.

Additionally, card 100 includes snap switch 120 that is in communication with microprocessors 108, 110 and/or 113 and power source 110. Snap switch 120 is configured to be engaged by a user tapping the card against a surface to activate the power source and provide power to the microprocessors 108, 110 and/or 113. The microprocessors 108, 110 and/or 113 use the power to energize the magnetic strips 112 and 114 for a predetermined period of time. The predetermined period of time is a limited period of time, for example, thirty seconds, so as to limit the amount of battery usage. In specific embodiments of the invention, the transactions instructions received from the transaction programming apparatus include the predetermined time period for energizing the magnetic strips 112 and 114. As such the period of time for energizing may be transaction-specific and vary based on the type of transaction being conducted or any other factor. Once the predetermined time period has expired, the microprocessors 108, 110, 113 no longer energize the magnetic strips 112 and 114 and reading of the data tracks is no longer feasible. If the time period expires, the user must re-tap the card 100 against a surface to engage the snap switch 120 and re-activate the power source 110 so as to re-energize the magnetic strips 112 and 114.

In alternate embodiments of the card 100 other means of activating the power source 110 may be implemented. For example, the card may include an accelerometer (not shown in FIG. 1). In such embodiments the removal of the card 100 from an accompanying transaction programming apparatus may provide the requisite motion in the accelerometer to supply voltage to the power source 110. Alternatively, the user may shake/wave the card upon removal of the card 100 from the transaction programming apparatus so as to provide for the requisite motion need by the accelerometer to supply voltage to the power source 110. In other embodiments the card 100 may include a conventional on/off switch on a facing of the card 100, which may be engaged by the user on an as needed basis.

In those embodiments in which power source 110 is a rechargeable cell battery, the rechargeable cell may be recharged by the transaction programming apparatus as long as the card is connected to transaction programming apparatus. In such embodiments, the rechargeable nature of the cell battery may obviate the need for a snap switch 120 or any other switch that regulates the on/off state of the power source 110.

As previously noted, the embodiment shown in FIG. 1 includes microprocessors 108, 110 and 113. The microprocessors 108, 110 and 113 may be configured to control various functions of card 100, including temporary storage of programming instructions received from the transaction programming apparatus, the writing of the programming instructions to the magnetic strips 112 and 114, the interaction between the snap switch 120 and power source 110 and the time-out period for energizing the magnetic strips. While the embodiment shown relies on three microprocessors 108, 100 and 113 for controlling the functionality of the card 100, in other embodiments fewer microprocessors may be required. For example, in one embodiment of the card 100, a single microprocessor may be implemented to control all of the functionality exhibited by card 100.

Additionally, in alternate embodiments of the card 100, one or more of the microprocessors 108, 110 and 113 may be capable of short range wireless communication, such as Near Field Communication (NFC) or the like to inhibit wireless communication (i.e., contactless) of the programming information in addition to or in lieu of contacted (i.e., magnetic strip) communication. Thus, in such embodiments of the invention, the card may include the magnetic strips 112 and 114 in addition to the short range wireless communication capability, while in other embodiments of the invention, in which short range wireless communication is the sole means for communicating the programmed information to a Point-Of-Sale (POS) device or other transaction accepting device, the magnetic strips 112 and 114 may not be required.

The use of multiple microprocessors 108, 100 and 113 may result in undesirable communication of infrared signals between the microprocessors. Such infrared signals may result in skewed voltages, noise and the like. As a means of lessening and/or eliminating the communication of infrared signals, once the microprocessors have been wire bonded or otherwise affixed to the printed circuit board 122, the microprocessors may be encased in an opaque epoxy or other substance that is impenetrable to light.

The magnetic strips 112 and 114 include copper coils (not shown in FIG. 2), which allow for the magnetic strips to be repeatedly re-programmed to allow for the dynamic re-programmability of the card 100. Each of the magnetic strips includes a corresponding track, referred to as track 1 and track 2. In the illustrated embodiment two magnetic strips 112 and 114 are shown, however, in other embodiments the card may include three or more magnetic strips/tracks. The magnetic strips/tracks 112 and 114 are configured to store the programming instructions as provided by the corresponding transaction programming apparatus. The magnetic strips 112 and 144 simulate standard bit rates, density and variance so that the card can be successfully read by any standard magnetic strip reader. In specific embodiments, all of the magnetic strips may be programmed and read simultaneously by card readers that support such functionality.

In specific embodiments of the invention, programming instructions may provide for one track to be configured to conduct a first transaction, e.g., a gift card payment transaction, and for another second track to be configured to conduct a second transaction, e.g., the balance of the payment via a credit card transaction. In such embodiments, the card may be programmed such that the first card reader swipe reads the gift card information and the second card reader swipe reads the preferred payment information for the balance amount (based on the gift card balance not provided enough credit for the entire transaction amount).

In one embodiment of the invention, the programming information is configured to “time-out” after a predetermined period of time, for example ten minutes, at which point all data is erased from the data tracks and the card powers down. In other embodiments the card is configured is capable of detecting when the data is read from the data tracks (i.e., when the card is swiped at a magnetic data reader). After the card has detected that the data has been read, the card is configured to “time-out” after another predetermined period of time, for example thirty seconds. If the card is re-swiped within the “time-out” period, the “time-out” period is re-set. The “time-outs” are configurable on a transaction-by-transaction basis as defined by the programming instructions.

In other optional embodiments of the invention, proper shielding is implemented between magnetic strips/tracks to ensure that bits do not jump between coils (i.e., leakage from one track to another)

In optional embodiments the card may include a display (not shown in FIG. 10 such as an e-ink display or the like. The display may be configured to display capture-able images, such as a bar code, Quick Response (QR) code or the like. In addition, the display may be configured to present a virtual image of conventional card, including the card-holders name, an account number, the type of card (i.e., VISA, MasterCard, American Express or the like), the card holder's chosen affinity, the card holder's signature or the like. In addition, the display may be configured to display a driver's license or information included on a driver's license, specifically a photograph of the card holder. The display may be configured to display all of the information simultaneously or in a rotating fashion.

The card 100 is typically embodied in a laminated construct. In one embodiment of the invention, a hot laminate process is employed to laminate the card 100. The hot lamination process provides for (1) pre-laminating both sides of the card with a protective film, (2) providing for a thick plastic sheet that out lies the periphery of each component on the card 110 (e.g., the connector, the microprocessor(s), the snap switch, etc.), (3) providing for a thin layer on top of the thick plastic sheet and (4) providing for a clear protective layer.

Thus, systems, apparatus, methods, and computer program products described above providing for a dynamically re-programmable transaction card that is capable of dynamically changing the information stored on the various data tracks included on the magnetic strip(s) of the card. The information may be payment information associated with payment card, such as a credit card, debit card, gift card or the like, such that a user may select a payment type/card for a pending transaction and the data tracks may be dynamically programmed just prior to the pending transaction to allow for a transaction to processed using the user-selected payment information. In this regard, during the period of time for which the transaction card is programmed, the card emulates the physical embodiment of the payment card selected by the user. In addition, to payment information the transaction card of the present invention may be dynamically programmed with any other information needed to conduct a transaction that is typically stored on other convention magnetic stripe cards, such as loyalty card information, key code information (e.g., card-like hotel keys) and the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A dynamically re-programmable transaction card device, the card device comprising:
a card body including one or more magnetic strips disposed on a facing of the card body, wherein the one or magnetic strips each include a data track that is dynamically re-programmable;
a connector disposed on a facing of the card body, wherein the connector is operable, upon connection to a programming device, to receive programming instructions; and
a processor in electrical communication with the connector and the magnetic strips, wherein the processor is operable to receive the programming instructions from the connector and energize the one or more magnetic strip with the programming instructions.
